(19) United States
(12) Patent Application Publication
(10) Pub. No.: US 2016/0069530 A1
(43) Pub. Date: Mar. 10, 2016

(54) Lampshade Assembly that is Assembly Quickly

(71) Applicant: TAIDER ELECTRIC MANUFACTURER CO., LTD., Dong Guan City (CN)

(72) Inventor: Ming-Chi Lin, Dong Guan City (CN)

(21) Appl. No.: 14/754,770

(22) Filed: Jun. 30, 2015

(30) Foreign Application Priority Data
Sep. 5, 2014 (CN) 201420508740.1

(51) Int. Cl. F21V 1/12; F21S 6/00

(52) U.S. Cl. CPC F21V 1/12; F21S 6/00

(57) ABSTRACT

A lampshade assembly includes a shade and a mounting seat. The shade is hollow and has an open end and a mounting end. The mounting end of the shade has an outer peripheral wall provided with a locking portion. The mounting seat has a plurality of claws movably locked onto and connected with the locking portion of the shade to mount the shade onto the mounting seat. Thus, when the mounting end of the shade is pushed toward the mounting seat, each of the claws of the mounting seat is pressed and locked into the locking portion of the shade to mount the shade onto the mounting seat.

### BACKGROUND OF THE INVENTION

1. Field of the Invention

The present invention relates to a lighting accessory and, more particularly, to a lampshade assembly for a lighting device, such as a lamp and the like.

2. Description of the Related Art

A conventional lampshade assembly comprises a mounting seat and a shade affixed to the mounting seat by a plurality of screws. The mounting seat has a plurality of screw bores. The shade has a plurality of screw bores. In assembly, the mounting seat is initially fixed, and the shade is then mounted on the mounting seat by the screws which are screwed through the screw bores of the mounting seat and the screw bores of the shade. However, it is difficult to align the screw bores of the mounting seat and the screw bores of the shade, thereby causing inconvenience to the operator in assembly of the mounting seat and the shade. In addition, the screws are easily detached from the screw bores during the assembly process and fall down onto the ground, thereby causing inconvenience to the operator, and thereby wasting the working time. Further, the screws are exposed outward from the shade, thereby decreasing the aesthetic quality of the lampshade assembly.

### BRIEF SUMMARY OF THE INVENTION

The primary objective of the present invention is to provide a lampshade assembly that is assembled quickly.

In accordance with the present invention, there is provided a lampshade assembly comprising a shade and a mounting seat. The shade is hollow and has an open end and a mounting end. The mounting end of the shade has an outer peripheral wall provided with a locking portion. The mounting seat has a plurality of claws movably locked onto and connected with the locking portion of the shade to mount the shade onto the mounting seat.

The locking portion of the shade is an annular groove to facilitate working design and assembly. The claws of the mounting seat are arranged in an annular manner. Each of the claws of the mounting seat is an elastic element that is located outside of the locking portion of the shade and is locked onto the locking portion of the shade.

The mounting seat has a cap structure with an opening facing downward. The mounting seat includes a plurality of elastic plates each of which is bent to form each of the claws. Each of the elastic plates is fixed on an inner side wall of the mounting seat.

The elastic plates of the mounting seat are arranged radially on the inner side wall of the mounting seat. The inner side wall of the mounting seat has an inner step. Each of the elastic plates has a movable end extending to an end portion of the mounting seat. The movable end of each of the elastic plates is arranged slantingly to facilitate guidance and mounting of the shade. Each of the claws of the mounting seat is formed on an inner top portion of the movable end of each of the elastic plates. Each of the claws of the mounting seat has an arch-shaped profile. Each of the elastic plates has an inner end portion which connected with each of the claws and is bent to form an abutment abutting the inner step of the mounting seat. The abutment of each of the elastic plates and the inner step of the mounting seat construct a restriction to prevent each of the claws from being retracted inward.

According to the primary advantage of the present invention, when the mounting end of the shade is pushed toward the mounting seat, each of the claws of the mounting seat is pressed and locked into the locking portion of the shade to mount the shade onto the mounting seat, so that the operator can mount and fix the shade quickly and conveniently in an energy-saving manner.

According to another advantage of the present invention, the lampshade assembly is assembled easily and quickly, thereby saving the operator's energy and time, and thereby enhancing the mounting efficiency.

According to a further advantage of the present invention, the outer surface of the shade does not have any screw bore and screw to enhance the aesthetic quality of the lampshade assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a lampshade assembly in accordance with the preferred embodiment of the present invention.

FIG. 2 is a perspective assembly view of the lampshade assembly as shown in FIG. 1.

### DETAILED DESCRIPTION OF THE INVENTION

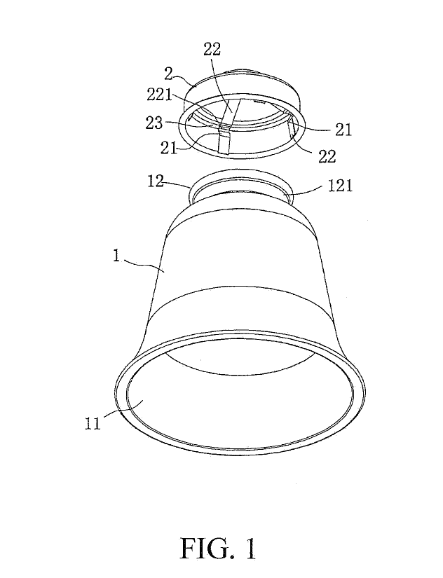

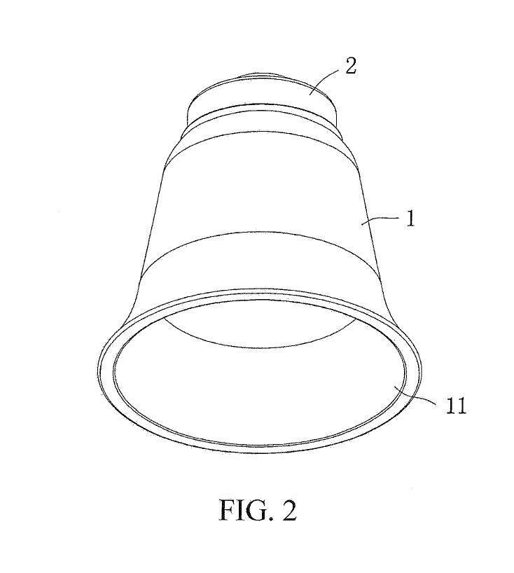

Referring to FIGS. 1 and 2, a lampshade assembly in accordance with the preferred embodiment of the present invention comprises a shade 1 and a mounting seat 2.

The shade 1 is hollow and has an open end 11 and a mounting end 12. The open end 11 of the shade 1 allows a light source to be emitted from the shade 1. The mounting end 12 of the shade 1 has an outer peripheral wall provided with a locking portion 121. In the preferred embodiment of the present invention, the locking portion 121 of the shade 1 is an annular groove to facilitate working design and assembly. Alternatively, the locking portion 121 of the shade 1 includes concave or convex portions arranged on the outer peripheral wall of the mounting end 12 of the shade 1.

The mounting seat 2 has a plurality of claws 21 movably locked onto and connected with the locking portion 121 of the shade 1 to mount the shade 1 onto the mounting seat 2. In the preferred embodiment of the present invention, the claws 21 of the mounting seat 2 are arranged in an annular manner. Each of the claws 21 of the mounting seat 2 is an elastic element that is located outside of the locking portion 121 of the shade 1 and is locked onto the locking portion 121 of the shade 1. In assembly, each of the claws 21 of the mounting seat 2 is initially pressed to pass through an upper edge of the locking portion 121 and is then restored and placed into the locking portion 121 of the shade 1 so that the shade 1 is stably mounted on the mounting seat 2. Then, the mounting seat 2 is fixed on a lamp frame or other object to facilitate mounting of the lamp. In such a manner, each of the claws 21 of the mounting seat 2 is movably locked onto and connected with the locking portion 121 of the shade 1 to mount the shade 1 onto the mounting seat 2, so that the operator can mount and fix the shade 1 quickly and conveniently in an energy-saving manner, without needing to use any screw. Thus, the outer surface of the shade 1 does not have any screw bore and screw so that the lampshade assembly has an excellent outer appearance.

As shown in FIG. 1, the mounting seat 2 has a cap structure with an opening facing downward. The mounting seat 2 includes a plurality of elastic plates 22 each of which is bent to form each of the claws 21. Each of the elastic plates 22 is fixed on an inner side wall of the mounting seat 2.

In the preferred embodiment of the present invention, the elastic plates 22 of the mounting seat 2 are arranged radially on the inner side wall of the mounting seat 2. The inner side wall of the mounting seat 2 has an inner step 23. Each of the elastic plates 22 has a movable end extending to an end portion of the mounting seat 2. The movable end of each of the elastic plates 22 is arranged slantingly to facilitate guidance and mounting of the shade 1. Each of the claws 21 of the mounting seat 2 is formed on an inner top portion of the movable end of each of the elastic plates 22. Each of the claws 21 of the mounting seat 2 has an arch-shaped profile. Each of the elastic plates 22 has an inner end portion which connected with each of the claws 21 and is bent to form an abutment 221 abutting the inner step 23 of the mounting seat 2. The abutment 221 of each of the elastic plates 22 and the inner step 23 of the mounting seat 2 construct a restriction to prevent each of the claws 21 from being retracted inward.

In assembly, the mounting seat 2 covers the mounting end 12 of the shade 1 to protect and enhance the aesthetic quality of the shade 1. At the same time, the abutment 221 of each of the elastic plates 22 and the inner step 23 of the mounting seat 2 limit and prevent each of the claws 21 from being retracted inward so that each of the claws 21 is operated normally and will not be deformed or broken by an external force so as to enhance the lifetime of each of the claws 21. In addition, each of the elastic plates 22 is bent to form each of the claws 21, and each of the elastic plates 22 is fixed on the mounting seat 2 by riveting, soldering, screwing or insertion, so that the lampshade assembly is worked and made easily, has a simplified construction and has a lower cost of fabrication.

Accordingly, when the mounting end 12 of the shade 1 is pushed toward the mounting seat 2, each of the claws 21 of the mounting seat 2 is pressed and locked into the locking portion 121 of the shade 1 to mount the shade 1 onto the mounting seat 2, so that the operator can mount and fix the shade 1 quickly and conveniently in an energy-saving manner. In addition, the lampshade assembly is assembled easily and quickly, thereby saving the operator's energy and time, and thereby enhancing the mounting efficiency. Further, the outer surface of the shade 1 does not have any screw bore and screw to enhance the aesthetic quality of the lampshade assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lampshade assembly comprising:
a shade and a mounting seat.
The shade is hollow and has an open end and a mounting end. The mounting end of the shade has an outer peripheral wall provided with a locking portion.
The mounting seat has a plurality of claws movably locked onto and connected with the locking portion of the shade to mount the shade onto the mounting seat.

2. The lampshade assembly of claim 1, wherein:
the locking portion of the shade is an annular groove to facilitate working design and assembly;
the claws of the mounting seat are arranged in an annular manner; and
each of the claws of the mounting seat is an elastic element that is located outside of the locking portion of the shade and is locked onto the locking portion of the shade.

3. The lampshade assembly of claim 1, wherein:
the mounting seat has a cap structure with an opening facing downward;
the mounting seat includes a plurality of elastic plates each of which is bent to form each of the claws; and
each of the elastic plates is fixed on an inner side wall of the mounting seat.

4. The lampshade assembly of claim 2, wherein:
the mounting seat has a cap structure with an opening facing downward;
the mounting seat includes a plurality of elastic plates each of which is bent to form each of the claws; and
each of the elastic plates is fixed on an inner side wall of the mounting seat.

5. The lampshade assembly of claim 3, wherein:
the elastic plates of the mounting seat are arranged radially on the inner side wall of the mounting seat;
the inner side wall of the mounting seat has an inner step;
each of the elastic plates has a movable end extending to an end portion of the mounting seat;
the movable end of each of the elastic plates is arranged slantingly to facilitate guidance and mounting of the shade;
each of the claws of the mounting seat is formed on an inner top portion of the movable end of each of the elastic plates;
each of the claws of the mounting seat has an arch-shaped profile;
each of the elastic plates has an inner end portion which connected with each of the claws and is bent to form an abutment abutting the inner step of the mounting seat; and
the abutment of each of the elastic plates and the inner step of the mounting seat construct a restriction to prevent each of the claws from being retracted inward.

6. The lampshade assembly of claim 4, wherein:
the elastic plates of the mounting seat are arranged radially on the inner side wall of the mounting seat;
the inner side wall of the mounting seat has an inner step;
each of the elastic plates has a movable end extending to an end portion of the mounting seat;
the movable end of each of the elastic plates is arranged slantingly to facilitate guidance and mounting of the shade;
each of the claws of the mounting seat is formed on an inner top portion of the movable end of each of the elastic plates;
each of the claws of the mounting seat has an arch-shaped profile;
each of the elastic plates has an inner end portion which connected with each of the claws and is bent to form an abutment abutting the inner step of the mounting seat; and
the abutment of each of the elastic plates and the inner step of the mounting seat construct a restriction to prevent each of the claws from being retracted inward.
